(19) United States
(12) Patent Application Publication
(10) Pub. No.: US 2015/0251773 A1
(43) Pub. Date: Sep. 10, 2015

(54) LOW-DENSITY PARTICLES FOR VEHICLE ARRESTING SYSTEMS

(71) Applicant: Engineered Arresting Systems Corporation, Aston, PA (US)

(72) Inventors: Shawn Doherty, Hockessin, DE (US); Silvia C. Valentini, West Chester, PA (US)

(21) Appl. No.: 14/639,354

(22) Filed: Mar. 5, 2015

Related U.S. Application Data
(60) Provisional application No. 61/948,141, filed on Mar. 5, 2014.

(51) Int. Cl. B64F 1/02; C09J 175/04; C04B 38/08; C08K 7/26; C04B 16/08; E01F 15/14; C09D 175/04

(52) U.S. Cl. CPC B64F 1/025; E01F 15/146; C09J 175/04; C09D 175/04; C08K 7/26; C04B 16/08; C04B 38/08

(57) ABSTRACT

Embodiments of the present invention provide systems and methods for vehicle arresting systems made from low-density particles and appropriate binders. The systems are designed to provide a barrier or a bed that is placed at the end of a runway or at the edge of a highway that will predictably and reliably crush (or otherwise deform) under the pressure of vehicle wheels traveling off the end of the runway or the edge of the road.

### CROSS REFERENCE TO RELATED APPLICATIONS

This application claims the benefit of U.S. Provisional Application Ser. No. 61/948,141, filed Mar. 5, 2014, titled “Low-density, bonded, inorganic/organic particles for vehicle arresting and other energy absorption systems,” the entire contents of which are hereby incorporated by reference.

### FIELD OF THE DISCLOSURE

Embodiments of the present disclosure relate generally to vehicle arresting systems made from low-density particles and appropriate binders. The systems are designed to provide a barrier or a bed that is placed at the end of a runway or at the edge of a highway that will predictably and reliably crush (or otherwise deform) under the pressure of vehicle wheels traveling off the end of the runway or the edge of the road.

### BACKGROUND

Aircraft can and do overrun the ends of runways, raising the possibility of injury to passengers and destruction of or severe damage to the aircraft. Such overruns have occurred during aborted take-offs or while landing, with the aircraft traveling at speeds up to 80 knots. In order to minimize the hazards of overruns, the Federal Aviation Administration (FAA) generally requires a safety area of one thousand feet in length beyond the end of the runway. Although this safety area is now an FAA standard, many runways across the country were constructed prior to adoption of this standard. These runways may be situated such that water, roadways, or other obstacles prevent economical compliance with the one thousand foot overrun requirement.

In order to alleviate the severe consequences of overrun situations, several materials, including existing soil surfaces beyond the runway, have been assessed for their ability to decelerate aircraft. However, soil surfaces are not the best solution for arresting moving vehicles (i.e. aircraft), primarily because their properties are unpredictable.

Another system that has been explored is providing a vehicle arresting system or other compressible system that includes material or a barrier placed at the end of a runway that will predictably and reliably crush (or otherwise deform) under the pressure of aircraft wheels traveling off the end of the runway. The resistance provided by the compressible, low-strength material decelerates the aircraft and brings it to a stop within the confines of the overrun area. Specific examples of vehicle arresting systems are called Engineered Materials Arresting Systems (EMAS), and are now part of the U.S. airport design standards described in FAA Advisory Circular 150/5220-22B “Engineered Materials Arresting Systems (EMAS) for Aircraft Overruns” dated Sep. 30, 2005. EMAS and Runway Safety Area planning are guided by FAA Orders 5200.8 and 5200.9.

A compressible (or deformable) vehicle arresting system may also be placed on or in a roadway or pedestrian walkway (or elsewhere), for example, for purposes of decelerating vehicles or objects other than aircraft. They may be used to safely stop cars, trains, trucks, motorcycles, tractors, mopeds, bicycles, boats, or any other vehicles that may gain speed and careen out of control, and thus need to be safely stopped.

Some specific materials that have been considered for arresting vehicles (particularly in relation to arresting aircraft), include phenolic foams, cellular cement, foamed glass, and chemically bonded phosphate ceramic (CBPC). These materials can be formed as a shallow bed in an arrestor zone at the end of the runway. When a vehicle enters the arrestor zone, its wheels will sink into the material, which is designed to create an increase in drag load.

However, some of the materials that have been explored to date can be improved upon. It is thus desirable to develop improved materials for vehicle arresting beds.

### BRIEF SUMMARY

Embodiments of the present disclosure relate generally to vehicle arresting systems made from low-density particles and appropriate binders. The systems are designed to provide a barrier or a bed that is placed at the end of a runway or at the edge of a highway that will predictably and reliably crush (or otherwise deform) under the pressure of vehicle wheels traveling off the end of the runway or the edge of the road.

### BRIEF DESCRIPTION OF THE FIGURES

FIG. 1 shows a perspective view of one embodiment of a structure that is formed from expanded perlite and a cementitious binder.

FIG. 2 shows a perspective view of one embodiment of a structure that is formed from expanded perlite and a polyurethane adhesive as the binder.

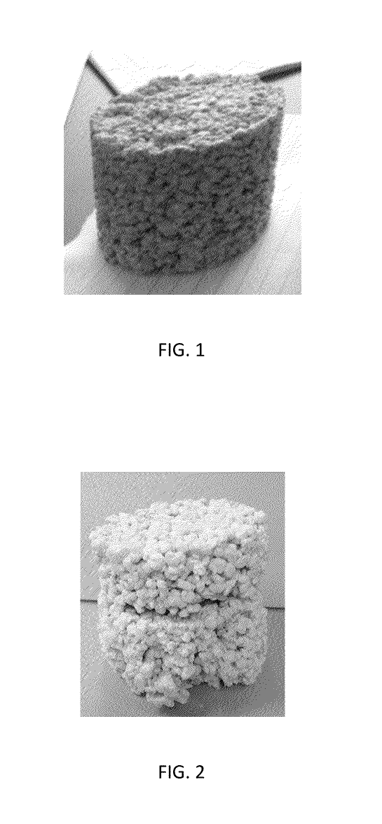

### DETAILED DESCRIPTION

One object of a vehicle arresting system is to fail in a predictable, specified manner, thereby providing controlled, predictable resistive force as a vehicle deforms the vehicle arresting system. A desired vehicle arresting system is thus generally a low-strength material that is compressible, deformable, crushable, or otherwise able to be compressed or deformed or crushed upon appropriate impact. The material strength should remain constant or at least not increase significantly with time. Additionally, the material strength should not be so high as to cause excessive vehicle damage or endanger the vehicle occupants' lives. The material should absorb the kinetic energy of a moving vehicle, rendering the system effective in stopping the vehicle, but preferably crushing and absorbing the energy to prevent serious injury or death to the vehicle occupants. In other words, the material should be strong enough that it absorbs the vehicle's energy and helps stop the vehicle safely by the system's ability to crush or deform upon impact, and not so strong that it causes the vehicle to crumple against the barrier. The system is intended to cause the vehicle to decelerate more slowly and to provide more cushion than a traditional barrier, and thus, may be referred to in some instances as a “non-lethal” vehicle arresting system. Materials that are too strong will render the intent of barrier useless.

Embodiments of the present invention thus provide an energy absorption system that has the desired low-density and low-strength. In one aspect, there is provided an energy absorption system that does not include cement as one of its components. In one aspect, there is provided an energy absorption system that includes low-density particles forming a body of the energy absorption system. There may also be a binder material added to the low-density particles. The binder may be any material that functions to maintain the low-density particles in place with respect to one another. Further details of various materials and parameters for the low-density particles and binders are outlined below.

In one aspect, there is provided an energy absorption system that includes low-density particles combined with a binder. The energy absorption system may be designed in the form of a vehicle arresting system, such as a vehicle arresting bed, designed to absorb energy from an overrun vehicle. The material forming the system may be bonded in such a way as to provide stability and durability to the system.

The following examples are provided for illustrative purposes only, and are not intended to be limiting in any way. In a specific example, the low-density particles may be organic and/or inorganic. The low-density particles may include but are not limited to perlite, vermiculite, expanded perlite, expanded vermiculite, clays, expanded clays, ceramics, slag, pumice, diatomaceous earth, industrial minerals, crushed lava rock, crushed shells, expanded polystyrene, ground plastic, combinations thereof. The low-density particles may be micro and/or macro particles. They may be in a powdery form or they may be granular. The low-density particles may range in size from about 0.1 mm to about 100 mm. The low-density particles may have varying geometries. For example, they may be generally round, jagged, irregular, dendritic, or any other shape. The low-density particles may be used in their natural form or they may be processed prior to being incorporated or otherwise mixed with an appropriate adhesive or binder. The low density particles may be a granular-like and/or powdery mix of material.

In a specific embodiment, the low-density particles may comprise expanded perlite. In another specific embodiment, low-density particles of perlite may be used, in various amounts or in various combinations with other elements. Perlite is a naturally-occurring amorphous volcanic glass that has a relatively high water content. Perlite has a property of greatly expanding when heated sufficiently. It also has a light weight after processing. In its unexpanded (“raw”) state, perlite has a bulk density of around 1100 kg/m³ (1.1 g/cm³). Expanded perlite has a bulk density of about 30-150 kg/m³ (0.03-0.150 g/cm³). This lower bulk density of expanded perlite can allow it to be a good candidate for the low-density particles described herein.

In another specific embodiment, the low-density particles may comprise expanded vermiculite. In another specific embodiment, low-density particles of vermiculite may be used, in various amounts or in various combinations with other elements. Vermiculite is a hydrous, silicate mineral that also expands greatly when heated.

A binder may be added to the low-density particles. The binder can be any number or combination of materials, such as adhesives or organic or inorganic materials, where a stable structure is formed by mixing, coating, or otherwise associating the particles with the binder. The following binder examples are provided for illustrative purposes only, and are not intended to be limiting in any way.

In a specific example, the binder may be a liquid adhesive, a polymer adhesive, a hot glue, a commercial adhesive such as Gorilla Glue® (either directly as provided or modified), an acrylic paint, a foam (such as a polyurethane foam), a polystyrene, and inorganic binder (such as clay or phosphate bonded ceramic), or combinations thereof that bind the low-density particles. The binder or combination of binders may be air-curing adhesives. The binder or combination of binders may be light-curing adhesives. The binder or combination of binders may be liquid adhesives. The binder or combination of binders chosen should generally be weak enough that they will reliably crush upon vehicle impact, but have sufficient strength to hold the particles together until an impact occurs. The binder or combination of binders chosen may be selected based on their viscosity, their ability to coat or otherwise adhere to the particles, their durability, UV stability, fire-resistance or retardance, or any other parameters. If the binder or combination of binders selected lacks one or more of the desired parameters, it is possible to provide a final coating to the system in order to impart the desired parameter(s).

Although the binder or combination of binders is generally not selected for any energy absorbing properties, it is possible that the binder selected may impart energy absorbing properties to the system as well. For example, if the binder selected is polyurethane foam, it is believed that the foam properties may add energy absorbing properties. For example, it may be possible to design or select a binder that has similar crushing properties as the low-density particles. If the binder selected does not provide any energy absorbing properties, it is believed that sufficient energy absorbing may be provided by the low-density particles selected and their combination with one or more binders in the manners described herein. In this example, the binder need only provide structural stability.

The system may also contain voids among the particles/binder array. These may be created by the reaction between the binder and the low-density particles. For example, if the particles used are perlite, they may expand upon application of heat. Another way to provide voids in the material is to incorporate a foam, incorporate a surfactant, or incorporate a chemical that will react to produce hydrogen or CO₂ or to create bubbles in the material. The general intent would be to provide pores or pockets of air in the material to lessen its strength and density. This may be beneficial to compensate for any adverse properties or strength that that binder may bring to the system.

The particles or the final product may also be coated, rolled, sprayed, or soaked (or other application method) with a moisture-resistant layer if needed or desired. Such a layer may include but is not limited to an alkali metal silicate, silicone derivate solution, sprayed elastomeric compounds, or any other suitable product intended to improve durability.

In one embodiment, the binder selected may coat the particles in order to render them water-resistant. In other embodiments, a separate solution to impart water- or moisture-resistance may be added. In one embodiment, a silicone solution may be added. Fillers or other materials may be added as well. These include but are not limited to sand, ash, slag, polymer fiber, glass fiber, straw, combinations thereof, or any other appropriate filler or material. Set or cure agents may also be added to the particles during mixture and/or to the final product that is formed.

During manufacture of the material, the ratio between the binder and the filler may be altered in order to arrive at the desired material strength, density, or other parameters. It is generally envisioned that there will be a greater amount of low-density particles than binder. The general intent is to use just enough binder to hold the particles together, but not so much binder that the resulting system has a strength that prevents it from crushing as desired. In one specific example, the ratio of binder to particles may be about 1:1 to about 1:20. In a nether specific example, the ratio of binder to particles may be from about 1:5 to about 1:10. In another specific example, the compressive strength of the resulting system may be about 5-100 pounds per square inch.

### Example 1

During formation, the materials may be added to form a slurry and then mixed or otherwise blended. The final body strength and material properties may be adjusted by changing the proportions of low density particles, the binder or filler, the amount of foam, surfactant, or pore-producing component added into the slurry, the filler composition and type (reactive or non-reactive) and amount, the mixing procedures, the mix time, the blending procedures, and/or the blend time. The solids/liquid ratio may vary with the binder (set/cure retardant) and filler types added, the binder/filler proportions, and final desired properties according to the intended end application for the material.

### Example 2

A combination of expanded perlite and liquid polyurethane adhesive is combined. The adhesive is mixed and then tumbled with the expanded perlite. The resulting material is allowed to air dry or otherwise cure. This allows the material to solidify into a hardened form. The resulting material had a granular outer appearance, with grains of particles held together with the adhesive. The resulting material was coated with a barrier layer to add water and weather-resistance. The coating used was a latex adhesive with a fire resistant additive, but it should be understood that other coatings are possible for use and considered within the scope of this disclosure.

### Example 3

A combination of expanded vermiculite and expanded polyurethane foam is combined. The adhesive is mixed and then tumbled with the expanded vermiculite. The resulting material is allowed to cure. This allows the material to solidify into a hardened form. The resulting material had a granular outer appearance, with grains of particles held together with the adhesive. The resulting material was coated with a barrier layer to add water and weather-resistance. The coating used was a foam latex coating, but it should be understood that other coatings are possible for use and considered within the scope of this disclosure.

### Example 4

Expanded balls or chips of polystyrene are mixed with a binder, such as a cementitious binder.

### Example 5

Recycled polystyrene beads and expanded perlite are mixed with a binder, such as phosphate bonded ceramic.

The resulting material from any of the above examples or otherwise made according to the disclosure herein may be formed into a vehicle arresting system. They may be formed into a series of blocks, panels, tiles, stacked or bonded bricks, small particles of material that are bonded together to form a structure, cylindrical or spherical units, or any other shape. The strength of the system and formulation used may be altered depending upon the vehicle or device to be safely stopped. If an aircraft is to be stopped, the barrier may be developed to have a higher strength than if a bicycle or pedestrian is to be stopped. In one embodiment, the barrier may have a compression strength of below about 100 psi, in some instances below about 50 psi, and in further instances around about 5 psi.

Changes and modifications, additions and deletions may be made to the structures and methods recited above and shown in the drawings without departing from the scope or spirit of the disclosure or the following claims.

What is claimed is:

1. A vehicle arresting system, comprising:
a plurality of low-density particles ranging from about 0.1 mm to about 100 mm; and
binder, where in the binder to particle ratio comprises about 1:1 to about 1:20, wherein a resulting mixture of the low-density particles and the binder has a compressive strength of less than about 100 psi.

2. The system of claim 1, wherein the low-density particles comprise perlite, vermiculite, expanded perlite, expanded vermiculite, clays, expanded clays, ceramics, slag, pumice, diatomaceous earth, industrial minerals, crushed lava rock, expanded polystyrene, ground plastic, or combinations thereof.

3. The system of claim 1, wherein the low-density particles comprise expanded perlite.

4. The system of claim 1, wherein the low-density particles comprise expanded vermiculite.

5. The system of claim 1, wherein the binder comprises liquid adhesive, polymer adhesive, hot glue, a commercial adhesive, an acrylic paint, a foam, a polystyrene, or combinations thereof.

6. The system of claim 1, wherein the binder comprises polyurethane foam.

7. The system of claim 1, wherein the system comprises a plurality of voids.

8. The system of claim 1, wherein the low-density particles and the binder are combined into blocks, panels, tiles, stacked or bonded bricks, or combinations thereof.

9. The system of claim 1, wherein the low-density particles are bonded together with the binder.

10. The system of claim 1, wherein the system comprises a coating that provides stability and durability.

11. The system of claim 10, wherein the coating comprises an organic or an inorganic coating.

12. A method of manufacturing the system of claim 1, comprising
forming a binder mixture;
adding low-density particles to the binder mixture;
mixing or blending the binder with the low-density particles to provide a mixed material;
forming a structure with the mixed material;
allowing the structure to cure or harden.

13. The method of claim 12, further comprising adding a surfactant.

14. The method of claim 12, further comprising adding a filler.

15. The method of claim 12, further comprising adjusting ratios between binder and low-density particles between about 1:1 to about 1:20 in order to obtain a desired final body strength.

16. The method of claim 12, further comprising adjusting mixing or blending procedures or mix time or both in order to obtain a desired final body strength.

17. The method of claim 12, wherein the structure formed comprises a vehicle arresting system.
